(19) United States
(12) Patent Application Publication
(10) Pub. No.: US 2015/0242114 A1
(43) Pub. Date: Aug. 27, 2015

(54) ELECTRONIC DEVICE, METHOD AND COMPUTER PROGRAM PRODUCT

(71) Applicant: KABUSHIKI KAISHA TOSHIBA, Tokyo (JP)

(72) Inventors: Hirotada Hirabayashi, Hamura Tokyo (JP); Junichi Nagata, Ome Tokyo (JP)

(21) Appl. No.: 14/576,728

(22) Filed: Dec. 19, 2014

(30) Foreign Application Priority Data
Feb. 27, 2014 (JP) 2014-036908

(51) Int. Cl. G06F 3/0488; G06T 11/60

(52) U.S. Cl. CPC G06F 3/04883; G06T 11/60; G06T 2200/24

(57) ABSTRACT

According to one embodiment, an electronic device includes circuitry. The circuitry is configured to input one or more characters corresponding to a plurality of handwritten strokes in a region of a display comprising a plurality of ruled lines at first intervals. The circuitry is configured to adjust a shape of the one or more characters when the size of the one or more characters is n times larger than the first interval, wherein n is greater than 0. The circuitry is configured to display the adjusted one or more characters.

### CROSS-REFERENCE TO RELATED APPLICATIONS

This application is based upon and claims the benefit of priority from Japanese Patent Application No. 2014-036908, filed Feb. 27, 2014, the entire contents of which are incorporated herein by reference.

### FIELD

Embodiments described herein relate generally to an electronic device, a method and a computer program product.

### BACKGROUND

In recent years, various electronic devices such as tablet computers, PDAs and a smartphones have been developed. Most of these electronic devices include a touchscreen display that facilitates input operations by the user.

Recently, electronic devices capable of processing handwritten character strings have been developed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an outward appearance of an electronic device according to an embodiment.

FIG. 2 is an illustration of an operation of a link between the electronic device according to the embodiment and an external device.

FIG. 3 is a sketch showing an example of a handwritten page on a display of the electronic device according to the embodiment.

FIG. 4 is an illustration of time-series data corresponding to the handwritten page shown in FIG. 3.

FIG. 5 is a block diagram showing a system configuration of the electronic device according to the embodiment.

FIG. 6 is a block diagram showing an example of a function configuration of a handwritten note application program in the electronic device according to the embodiment.

FIG. 7 is an illustration of a typical handwritten page formatting process performed by a handwritten note application program.

FIG. 8 is an illustration of a typical handwritten page formatting process performed by the handwritten note application program.

FIG. 9 is an illustration of a scaling icon displayed on the display by the handwritten note application program.

FIG. 10 is an illustration of a handwritten page formatting process performed in linkage with a candidate presenting process by the handwritten note application program.

FIG. 11 is an illustration of a handwritten page formatting process performed in linkage with the candidate presenting process by the handwritten note application program.

FIG. 12 is an illustration of another handwritten page formatting process performed in linkage with the candidate presenting process by the handwritten note application program.

FIG. 13 is an illustration of another handwritten page formatting process performed in linkage with the candidate presenting process by the handwritten note application program.

FIG. 14 is an illustration of another handwritten page formatting process performed by the handwritten note application program.

FIG. 15 is an illustration of another handwritten page formatting process performed by the handwritten note application program.

FIG. 16 is an illustration of a modification to the handwritten page formatting process performed by the handwritten note application program.

FIG. 17 is an illustration of a modification to the handwritten page formatting process performed by the handwritten note application program.

FIG. 18 is a flowchart showing a typical handwritten page formatting process performed by the handwritten note application program.

### DETAILED DESCRIPTION

Various embodiments will be described hereinafter with reference to the accompanying drawings.

In general, according to one embodiment, an electronic device includes circuitry. The circuitry is configured to input one or more characters corresponding to a plurality of handwritten strokes in a region of a display comprising a plurality of ruled lines at first intervals. The circuitry is configured to adjust a shape of the one or more characters when the size of the one or more characters is n times larger than the first interval, wherein n is greater than 0. The circuitry is configured to display the adjusted one or more characters.

FIG. 1 is a perspective view showing an outward appearance of an electronic device according to the embodiment. The electronic device is, for example, a stylus-based portable electronic device capable of handwriting input using a stylus or a finger. This electronic device can be achieved as a tablet computer, a notebook personal computer, a smartphone, a PDA or the like. Hereinafter, it is assumed that the electronic device is achieved as a tablet computer 10. The tablet computer 10 is a portable electronic device that is called a tablet or a slate computer. As shown in FIG. 1, the tablet computer 10 includes a main body 11 and a touchscreen display 17. The touchscreen display 17 is put on the top surface of the main body 11.

The main body 11 includes a thin, box-shaped housing. The touchscreen display 17 incorporates a flat panel display and a sensor configured to sense a contact position of a stylus or a finger on the screen of the flat panel display. As the flat panel display, for example, a liquid crystal display (LCD) can be used. As the sensor, for example, a capacitance type touchpanel and an electromagnetic induction type digitizer can be used. Hereinafter, it is assumed that two different sensors of a digitizer and a touchpanel are incorporated into the touchscreen display 17.

The touchscreen display 17 makes it possible to detect a touch operation on the screen using a stylus 100 as well as a touch operation on the screen using a finger. As the stylus 100, for example, a digitizer stylus (electromagnetic induction stylus) can be used. A user can use the stylus 100 to perform a handwriting input operation on the touchscreen display 17. During the handwriting input operation, the paths of the stylus 100 on the screen, or the strokes (paths of handwritten strokes) handwritten by the handwriting input operation are drawn in real time, with the result that the strokes input in handwriting are displayed on the screen. The path of the stylus 100 that is in contact with the screen corresponds to one stroke. A large number of strokes corresponding to, for example, handwritten characters, handwritten figures and handwritten tables constitute a handwritten page.

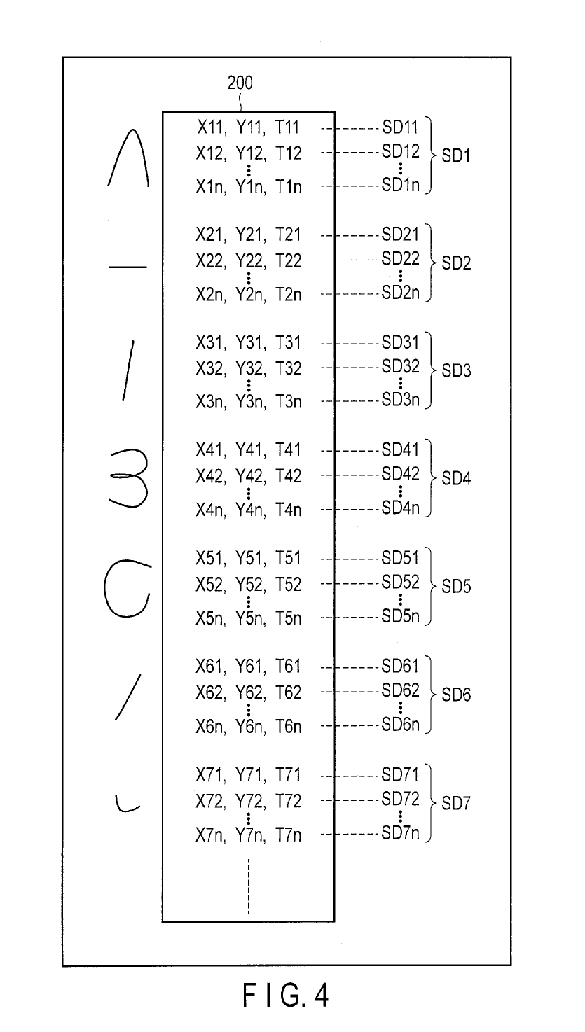

In the present embodiment, the handwritten page is stored in a storage medium as not image data but time-series data (handwritten page data) indicating a coordinate sequence of paths of strokes and a relationship in order between the strokes. Though the time-series data will be described in detail later with reference to FIG. 4, it represents the order in which a plurality of strokes are handwritten and includes a plurality of stroke data items corresponding to the plurality of strokes. In other words, the time-series data means a set of time-series stroke data items corresponding to a plurality of strokes. Each of the stroke data items corresponds to one stroke and includes a coordinate data series (time-series coordinates) corresponding to points on the path of the stroke. The order of the stroke data items corresponds to the order in which the strokes are handwritten.

The tablet computer 10 is able to read the existing time-series data out of the storage medium and display on the screen a handwritten page corresponding to the time-series data, or a plurality of strokes represented by the time-series data. The plurality of strokes represented by the time-series data are also input in handwriting.

The tablet computer 10 of the present embodiment has a touch input mode to perform a handwriting input operation not using the stylus 100 but using a finger. When the touch input mode is available, a user can perform a handwriting input operation on the touchscreen display 17 using his or her finger. During the handwriting input operation, the path of the finger on the screen, or the strokes (paths of handwritten strokes) handwritten by the handwriting input operation are drawn in real time, with the result that the strokes input in handwriting are displayed on the screen.

The tablet computer 10 also has an editing function. The editing function allows a user to delete or move an arbitrary handwritten portion (a handwritten character, a handwritten mark, a handwritten figure, a handwritten table, etc.) in a handwritten page which is being displayed and selected by a range selection tool in accordance with user's editing operations using an eraser tool, a range selection tool, various other tools and the like. The editing function also allows a user to designate the arbitrary handwritten portion as a retrieval key. Furthermore, the editing function allows a user to perform a recognition process, such as a handwritten character recognition process, a handwritten figure recognition process and a handwritten table recognition process for the arbitrary handwritten portion.

In the present embodiment, the handwritten page can be managed as one or more pages. Time-series data (handwritten page data) can be divided in units of area to fall within one screen and thus time-series data that falls within one screen can be recorded as one page or the size of the page can be varied. The size of the page can be increased more than that of one screen and thus the handwritten page, which is larger than the screen, can be processed as one page. When the entire contents of one page cannot be displayed at once on the display, the page can be reduced or a target portion to be displayed within the page can be moved by a vertical/horizontal scroll.

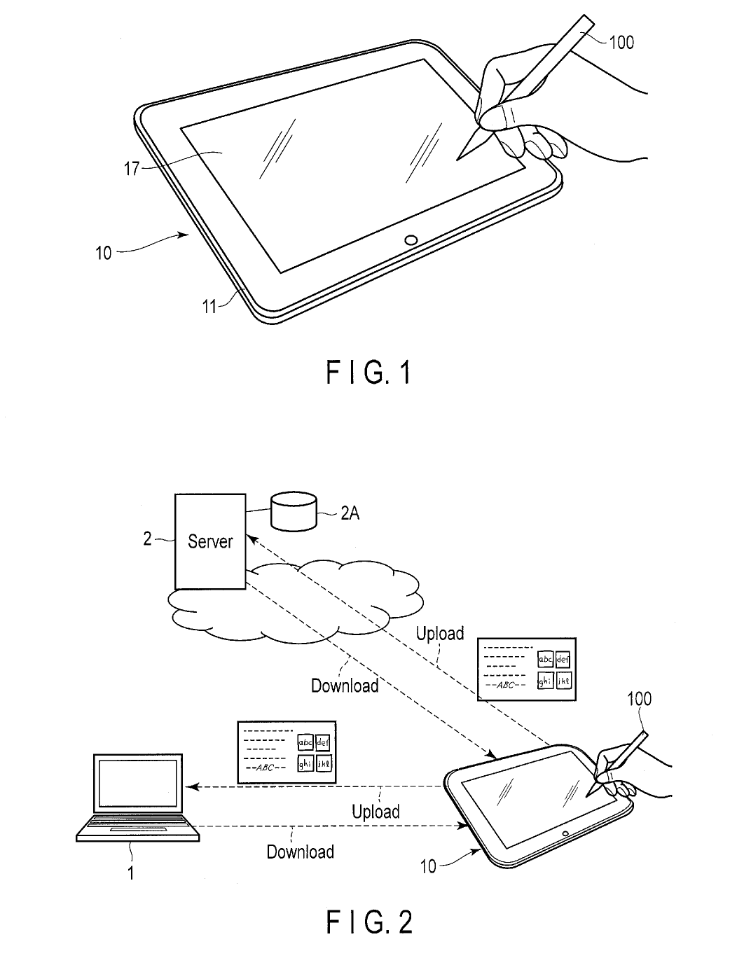

FIG. 2 illustrates an example of a link between the tablet computer 10 and an external device. The tablet computer 10 is able to link with the personal computer 1 and a cloud. More specifically, the tablet computer 10 includes a wireless communication device such as a wireless LAN and is able to carry out wireless communications with the personal computer 1. The tablet computer 10 is also able to carry out communications with a server 2 on the Internet. As the server 2, a server that executes an online storage service and other different cloud computing services can be employed.

The personal computer 1 includes a storage device such as a hard disk drive (HDD). The tablet computer 10 is able to transmit time-series data (handwritten page data) to the personal computer 1 over the network and record the time-series data in the HDD of the personal computer 1 (upload). In order to carry out secure communications between the tablet computer 10 and the personal computer 1, the personal computer 1 may authenticate the tablet computer 10 at the start of communications. In this case, a dialog to prompt a user to input his or her ID or password can be displayed on the screen of the tablet computer 10 or, for example, an ID of the tablet computer 10 can be transmitted automatically to the personal computer 1 from the tablet computer 10.

If, therefore, the capacity of the storage in the tablet computer 10 is small, the tablet computer 10 is able to process a large number of items of time-series data or a large amount of time-series data.

The tablet computer 10 is able to read at least one time-series data item out of the HDD of the personal computer 1 (download) and display a stroke represented by the read time-series data item on the screen of the display 17 of the tablet computer 10. In this case, a list of thumbnails obtained by reducing a page of each of the time-series data items, can be displayed on the screen of the display 17 and one page selected from the thumbnails can be displayed in normal size on the screen of the display 17.

A destination with which the tablet computer 10 communicates is not the personal computer 1 but may be the server 2 on the cloud that provides a storage service and the like, as described above. The tablet computer 10 is able to transmit time-series data (handwritten page data) to the server 2 over the network and record the time-series data in a storage device 2A of the server 2 (upload). The tablet computer 10 is also able to read arbitrary time-series data out of the storage device 2A of the server 2 (download) and display a path of each of the strokes represented by the time-series data on the screen of the display 17 of the tablet computer 10.

In the foregoing embodiment, the storage device in the tablet computer 10, the storage device in the personal computer 1 or the storage device 2A in the server 2 can be used as the storage medium in which time-series data is stored.

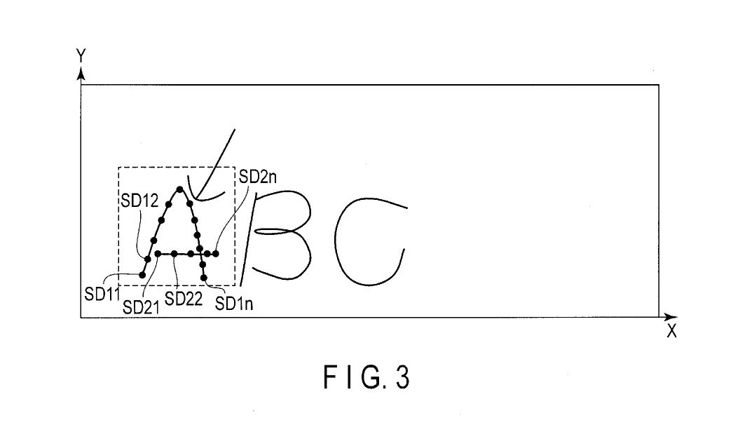

The relationship between strokes (characters, figures, tables, etc.) handwritten by a user and time-series data will be described with reference to FIGS. 3 and 4. FIG. 3 shows an example of a handwritten page (handwritten character string) handwritten on the touchscreen display 17 using the stylus 100 or the like.

In most handwritten pages, for example, on the character and figure input in handwriting, another character and figure are input in handwriting. In FIG. 3, letters A, B and C are input in handwriting in the order presented as a handwritten letter string “ABC” and then an arrow is input in handwriting just close to the handwritten letter A.

The handwritten letter A is represented by two strokes (“̂” and “−”) handwritten using, for example, the stylus 100, namely, two paths. The path of “̂” handwritten first using the stylus 100 is sampled in real time at regular intervals, for example, thus obtaining time-series coordinates SD11, SD12, . . . , SD1n of the stroke “̂”. Similarly, the path of “−” handwritten next using the stylus 100 is also sampled in real time at regular intervals, thus obtaining time-series coordinates SD21, SD22, . . . , SD2n of the stroke “−”.

The handwritten letter B is represented by two strokes handwritten using, for example, the stylus 100, namely, two paths. The handwritten letter C is represented by one stroke handwritten using, for example, the stylus 100, namely, one path. The handwritten arrow is represented by two strokes handwritten using, for example, the stylus 100, namely, two paths.

FIG. 4 shows time-series data 200 corresponding to the handwritten page shown in FIG. 3. The time-series data 200 includes a plurality of stroke data items SD1, SD2, . . . , SD7. These stroke data items SD1, SD2, . . . , SD7 are arranged in time series in the handwritten order.

In the time-series data 200, the first two stroke data items SD1 and SD2 represent two strokes of handwritten letter A. The third and fourth stroke data items SD3 and SD4 represent two strokes of handwritten letter B. The fifth stroke data item SD5 represents one stroke of handwritten letter C. The sixth and seventh stroke data items SD6 and SD7 represent two strokes of handwritten arrow.

Each of the stroke data items includes a coordinate data series (time-series coordinates) corresponding to one stroke, or a plurality of coordinates corresponding to a plurality of points on the path of one stroke. These coordinates are arranged in time series in the order the strokes are handwritten. As for handwritten letter A, stroke data item SD1 includes a coordinate data series (time-series coordinates) corresponding to the points on the path of stroke “̂” of handwritten letter A, or n coordinate data items SD11, SD12, . . . , SD1n. Stroke data item SD2 includes a coordinate data series corresponding to the points on the path of stroke “−” of handwritten letter A, or n coordinate data items SD21, SD22, . . . , SD2n. The number of coordinate data items may vary from stroke data to stroke data.

Each of the coordinate data items represents x- and y-coordinates corresponding to one point on the path. For example, coordinate data item SD11 represents the x-coordinate (X11) and y-coordinate (Y11) of the start point of the stroke “A” and coordinate data item SD1n represents the x-coordinate (X1n) and y-coordinate (Y1n) of the end point of the stroke “A”.

Each of the coordinate data items may include timestamp data T corresponding to the point in time when a point corresponding to the coordinates is handwritten. The point in time may be absolute time (for example, year, month, day, hour, minute and second) or relative time based on a point in time. For example, absolute time (for example, year, month, day, hour, minute and second) when a stroke is started to be handwritten can be added to each stroke data item as timestamp data and relative time indicative of a difference from the absolute time can be added to each coordinate data item in the stroke data as timestamp data T.

As described above, a temporal relationship between strokes can be represented with precision by using time-series data in which timestamp data T is added to each of the coordinate data items.

Furthermore, data (Z) indicative of handwriting pressure can be added to each of the coordinate data items.

The time-series data 200 having a structure as described with reference to FIG. 4 is able to represent a temporal relationship between stokes as well as handwriting of each divisional stroke. Therefore, even though the point of the arrow is handwritten to overlap the handwritten letter A or very close to the handwritten letter A as shown in FIG. 3, the time-series data 200 makes it possible to process the handwritten letter A and the point of the handwritten arrow as different letters or figures.

In the present embodiment, as described above, the handwritten page data is not stored as a result of image or character recognition but as the time-series data 200 including a set of time-series stroke data items. The handwritten characters can thus be processed without relying upon the language thereof. Accordingly, the structure of the time-series data 200 can be used in a variety of countries of different languages.

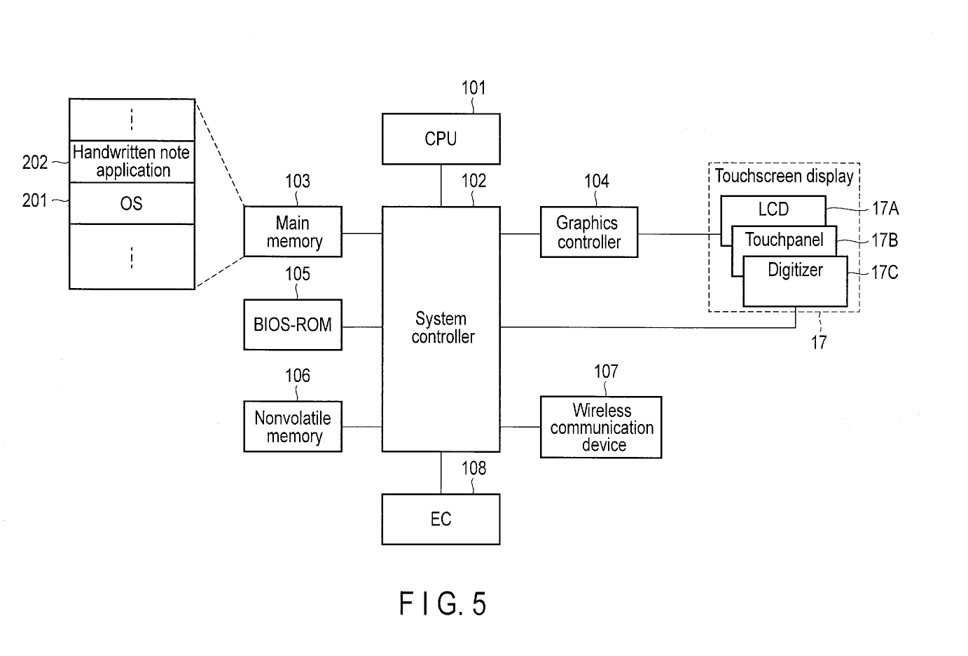

FIG. 5 shows a system configuration of the tablet computer 10.

As shown in FIG. 5, the tablet computer 10 includes a CPU 101, a system controller 102, a main memory 103, a graphics controller 104, a BIOS-ROM 105, a nonvolatile memory 106, a wireless communication device 107 and an embedded controller (EC) 108.

The CPU 101 is a processor that controls the operations of different modules in the tablet computer 10. The CPU 101 executes different software programs which are loaded into the main memory 103 from the nonvolatile memory 106 that is a storage device. These software programs include an operating system (OS) 201 and different application programs. The application programs include a handwritten note application program 202. The handwritten note application program 202 has a function of creating and displaying the above-described handwritten page data, a function of editing handwritten page data and a function of retrieving handwritten page data including a desired handwritten portion and a desired handwritten portion in handwritten page data.

The CPU 101 executes a basic input/output system (BIOS) stored in the BIOS-ROM 105. The BIOS is a program for controlling hardware.

The system controller 102 is a device that connects a local bus of the CPU 101 and different components. The system controller 102 includes a memory controller that controls access to the main memory 103. The system controller 102 has a function of performing communications with the graphics controller 104 via, for example, a serial bus conforming to the PCI EXPRESS standard.

The graphics controller 104 is a display controller for controlling an LCD 17A that is used as a display monitor of the tablet computer 10. The graphics controller 104 generates a display signal and sends it to the LCD 17A. The LCD 17A displays a screen image based on the display signal. The LCD 17A, a touchpanel 17B and a digitizer 17C are put one on another. The touchpanel 17B is a capacitance type pointing device for inputting on the screen of the LCD 17A. The touchpanel 17B is designed to detect a position on the screen which a user touches with his or her finger, a movement of the finger from the position, and the like. The digitizer 17C is an electromagnetic induction type pointing device for inputting on the screen of the LCD 17A. The digitizer 17C is designed to detect a position on the screen which a user touches with the stylus (digitizer stylus) 100, a movement of the stylus 100 from the position, and the like.

The wireless communication device 107 is a device configured to carry out wireless communications such as a wireless LAN and 3G mobile communications. The EC 108 has a function of turning on or turning off the tablet computer 10 in response to a user's operation of a power button.

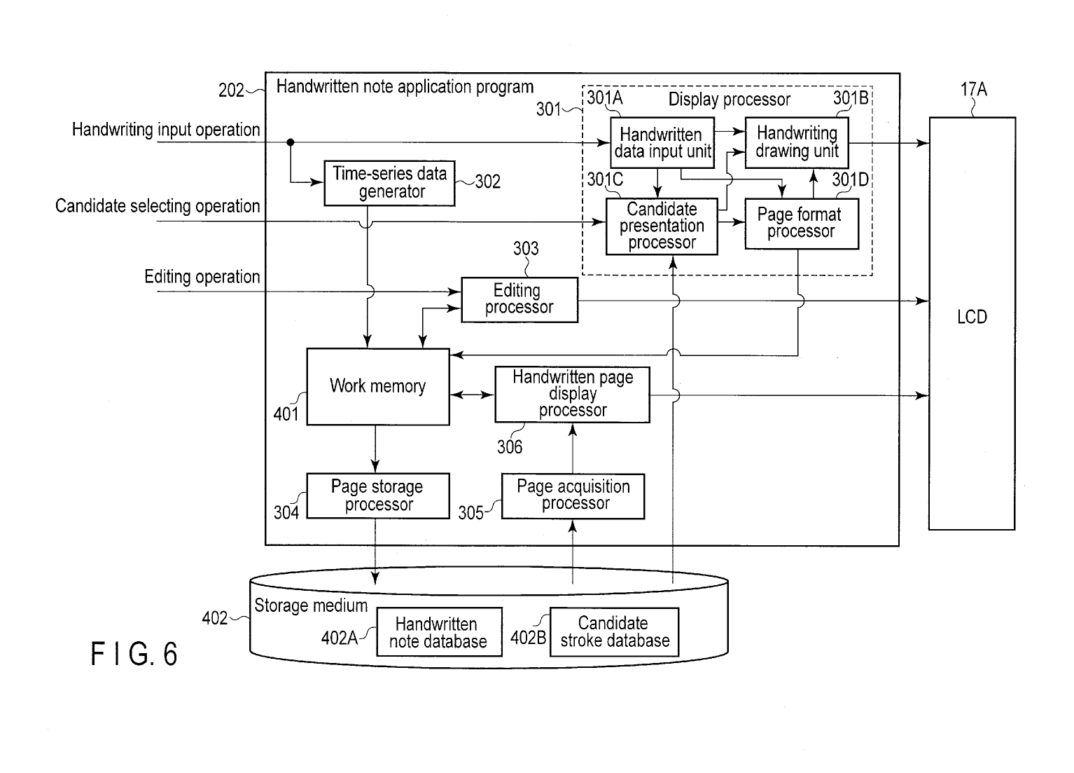

The function configuration of the handwritten note application program 202 will be described with reference to FIG. 6.

The handwritten note application program 202 includes a display processor 301, a time-series data generator 302, an editing processor 303, a page storage processor 304, a page acquisition processor 305 and a handwritten page display processor 306. The display processor 301 includes a handwritten data input unit 301A, a handwriting drawing unit 301B, a candidate presentation processor 301C and a page format processor 301D.

The handwritten note application program 202 is executed to, for example, create, display and edit a handwritten page using stroke data input by means of the touchscreen display 17. The touchscreen display 17 is configured to detect an occurrence of an event, such as a touch, move (slide) and release. The touch is an event indicating that an external object touches the screen of the display. The move (slide) is an event indicating that a position on the screen which an external object touches has moved. The release is an event indicating that an external object is released from the screen.

The display processor 301 and time-series data generator 302 receive an event of touch or move (slide) generated by the touchscreen display 17 to detect a handwriting input operation. The touch event includes coordinates of a touch position. The move (slide) event also includes coordinates of a destination to which a touch position has moved. Thus, the display processor 301 and time-series data generator 302 are able to receive a coordinate sequence corresponding to the paths of movement of the touch position from the touchscreen display 17.

The handwritten note application program 202 can be executed to display a plurality of ruled lines, which are drawn at regular intervals, on the screen at the time of creation, display and editing of a handwritten page. The display of the ruled lines can arbitrarily be turned on or off by a user. The interval between the ruled lines can arbitrarily be set by a user. The handwritten note application program 202 can be executed to display grid lines, which are drawn at regular intervals, on the screen in place of the ruled lines. The display of the grid lines can also arbitrarily be turned on or off by a user. Hereinafter, it is assumed that a plurality of ruled lines are displayed at first intervals at the time of creation, display and editing of a handwritten page.

The handwritten page formatting process, which will be described later, can be performed when a plurality of ruled lines are displayed on the screen. Even though a plurality of ruled lines are not displayed on the screen, the handwritten note application program 202 can be executed when a recognizable logical ruled line is set. When the first stroke has a length which is not less than a predetermined threshold value, the handwritten page formatting process need not be executed as determining that the stroke is handwritten intentionally by a user.

The display processor 301 is configured to display a handwritten stroke on the screen in accordance with the movement of an object (stylus 100) on the screen which is detected by the digitizer 17C. With the display processor 301, the path of the stylus 100 that is touching the screen of the LCD 17A, or the path of each stroke is displayed on the screen of the LCD 17A.

The time-series data generator 302 receives the foregoing coordinate sequence from the touchscreen display 17. On the basis of the coordinate sequence, the foregoing time-series data having a structure as described in detail with reference to FIG. 4 is generated and, in this case, the time-series data, or the coordinates and timestamp data corresponding to the points of a stroke can temporarily be stored in a work memory 401.

The editing processor 303 performs a process to edit the currently-displayed handwritten page. More specifically, the editing processor 303 performs a process to, for example, delete or move one or more of the strokes displayed, in accordance with a user's editing operation on the touchscreen display 17. Furthermore, the editing processor 303 updates the time-series data to reflect a result of the editing process in time-series data that is being displayed.

The page storage processor 304 stores the generated time-series data in a handwritten note database 402A in a storage medium 402 as a handwritten page. As described above, the storage device in the tablet computer 10, the storage device in the personal computer 1 or the storage device 2A in the server 2 can be used as the storage medium 402.

The page acquisition processor 305 reads arbitrary time-series data from the handwritten note database 402A in the storage medium 402. The read time-series data is sent to the handwritten page display processor 306. The handwritten page display processor 306 analyzes the time-series data and, on the basis of a result of the analysis, displays on the screen a path of each of the strokes indicated by the time-series data.

The foregoing display processor 301 will be described in detail.

As described above, the touchscreen display 17 detects a touch operation (handwriting input operation) on the screen by means of the touchpanel 17B or the digitizer 17C. The handwritten data input unit 301A is a module for inputting a detection signal from the touchpanel 17B or the digitizer 17C. The detection signal includes coordinate data (X, Y) of the touch position. If such detection signals are input in chronological order, the handwritten data input unit 301A inputs stroke data corresponding to the strokes handwritten on the display, for example. The stroke data input by the handwritten data input unit 301A is supplied to the handwriting drawing unit 301B when an operation to determine the handwriting input operation is performed, it is supplied to the candidate presentation processor 301C when an operation to determine the handwriting input operation is not performed, and it is supplied to the candidate presentation processor 301C and the page format processor 301D when an operation to determine the handwriting input operation is not performed and when one or more characters corresponding to a plurality of handwritten strokes corresponding to the stroke data are n or m times larger than the first interval (m≠n). The value of n or that of m need not be correctly determined when the stroke data is input to the handwritten data input unit 301A. It has only to be determined whether one or more characters corresponding to a plurality of handwritten strokes corresponding to the stroke data are larger or smaller than the first interval.

The handwriting drawing unit 301B is a module for drawing paths (handwriting) of data input in handwriting and then displaying the paths on the LCD 17A of the touchscreen display 17. The handwriting drawing unit 301B draws segments corresponding to the paths (handwriting) of data input in handwriting on the basis of the stroke data from the handwritten data input unit 301A, the candidate presentation processor 301C or the page format processor 301D.

The candidate presentation processor 301C is a module configured to perform a candidate presenting process. More specifically, the candidate presentation processor 301C acquires one or more stroke strings (handwritten character strings), which correspond to the handwritten strokes (stroke data supplied from the handwritten data input unit 301A), from a set of input strokes (handwritten page data). Then, the candidate presentation processor 301C performs a process for displaying the acquired stroke strings on the screen as a candidate for strokes that can be input (candidate strokes).

In other words, the candidate presentation processor 301C predicts a stroke string that a user is going to handwrite, on the basis of strokes to be input and handwritten page data. Then, the candidate presentation processor 301C presents a user with some stroke strings (stroke groups) obtained by the prediction, as candidate strokes.

For example, when stroke “a” is input in handwriting, a candidate such as a handwritten letters “add” or “access” can be presented to a user. If the user chooses the handwritten letters “access,” the handwritten letters “access” will be an input stroke string. Thus, the user can easily input a stroke string of the handwritten letters “access”.

Whatever language is available as the language of a stroke string (handwritten character string) stored as handwritten page data. Available languages are, for example, English, Japanese, Chinese and other languages. As for an English stroke string, the stroke string may correspond to block letters or cursive letters. A word written in cursive script may be constituted of a single stroke. Accordingly, a stroke string acquired from the handwritten page data in the candidate presenting process need not always include a plurality of strokes but may be a single stroke.

As an example of a stroke string corresponding to input strokes, there are a plurality of strokes including strokes similar to input strokes and a single stroke including a stroke portion similar to input strokes. For example, a stroke string whose first stroke (or first stroke portion) is similar to an input stroke, is acquired from the handwritten page data.

In order to acquire a stroke string corresponding to an input stroke easily from the handwritten page data, the candidate presentation processor 301C may create a candidate stroke database 402B on the basis of a set of strokes stored in the handwritten note database 402A. In this candidate stroke database 402B, for example, a stroke string and a character recognition result (character string) corresponding to the stroke string can be stored in units of meaningful character string, such as a word.

First, the candidate presentation processor 301C character-recognizes a stroke input by a user. Referring then to the candidate stroke database 402B, the candidate presentation processor 301C retrieves a character string whose prefix corresponds to the character recognition result (character string) of the input stroke. After that, the candidate presentation processor 301C acquires a stroke string corresponding to the retrieved character string from the candidate stroke database 402B as a stroke string corresponding to the input stroke.

In the candidate stroke database 402B, for example, a stroke string and a feature amount of each of the strokes corresponding to the stroke string can be stored in units of meaningful character string, such as a word. As a feature amount of a stroke, an arbitrary feature capable of representing a handwriting feature of the stroke can be used. More specifically, as the feature amount, feature amount data representing, for example, a shape of the stroke, a direction thereof and a slope thereof can be used. In this case, the candidate presentation processor 301C may acquire a stroke string having a feature amount similar to the feature amount of the input stroke from the candidate stroke database 402B.

In the candidate stroke database 402B, for example, a stroke string, a character recognition result (character string) corresponding to the stroke string and a feature amount of each of the strokes corresponding to the stroke string can be stored in units of meaningful character string, such as a word.

In summary, the candidate presentation processor 301C predicts a stroke string that a user is going to input, on the basis of an input stroke and the candidate stroke database 402B. In this prediction process, the candidate presentation processor 301C acquires some stroke strings (stroke groups) corresponding to the input stroke from the candidate stroke database 402B. Then, the candidate presentation processor 301C performs a process to display the stroke strings on the screen as candidates of stroke strings (candidate strokes) whose input is predicted.

The page format processor 301D is a module for performing a handwritten page formatting process to format a handwritten stroke corresponding to stroke data. More specifically, the page format processor 301D performs a handwritten page formatting process to, when one or more characters corresponding to the plurality of strokes are n (or m) times larger than the first interval, adjust a shape of a plurality of handwritten strokes corresponding to stroke data (which is supplied from the handwritten data input unit 301A or both of the handwritten data input unit 301A and the candidate presentation processor 301C), and then display the shape-adjusted handwritten strokes on the screen. The shape of a plurality of handwritten strokes corresponding to stroke data is adjusted so as to fall within an area between n+1 (or m+1) ruled lines (so as to match n+1 (or m+1) ruled lines) in accordance with a size of n or m times larger than the first interval. In other words, when strokes are handwritten over a plurality of lines (or a stroke is handwritten considerably smaller than the first interval), the page format processor 301D performs a process to adjust a shape of the handwritten strokes and display the shape-adjusted handwritten strokes on the screen. In the present embodiment, it is assumed that the above n is a value of one or more and the above m is a value of less than one.

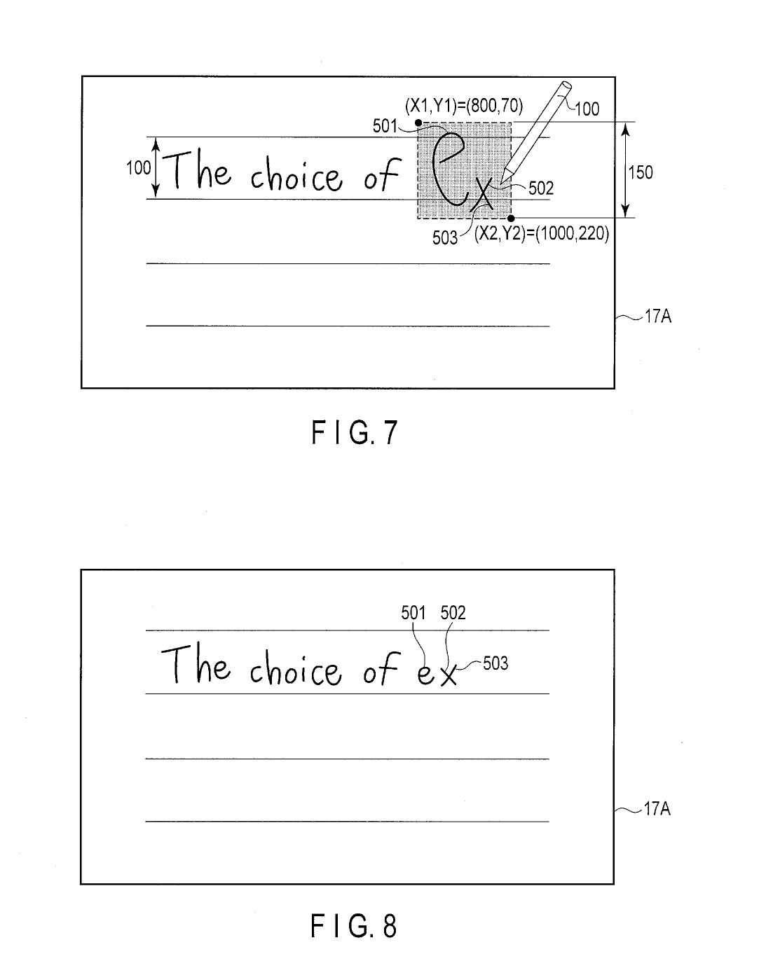

A typical handwritten page formatting process will be described in detail with reference to FIGS. 7 and 8.

FIGS. 7 and 8 are figures for illustrating a typical handwritten page formatting process. As illustrated in FIG. 7, when handwritten letters “ex” corresponding to handwritten strokes 501-503 of a plurality of handwritten strokes corresponding to stroke data is n times larger than the first interval, the page format processor 301D first performs a process to surround the handwritten letters “ex” with a rectangular frame (a circumscribed rectangle). Then, the page format processor 301D computes, for example, an upper left coordinate, a lower right coordinate, height and center of gravity of the rectangular frame. It is assumed in FIG. 7 that the upper left coordinate (X1, Y1) of the circumscribed rectangle is (800, 70), the lower right coordinate (X2, Y2) thereof is (1000, 220), the height thereof is 150 (=Y2−Y1) and the center of gravity thereof is 75 (=height/2). It is also assumed in FIG. 7 that the first interval is set to 100. In FIG. 7, the rectangular frame that surrounds the handwritten letters “ex” corresponding to handwritten strokes 501-503 for which the handwritten page formatting process is performed, is displayed on the screen. However, the rectangular frame need not be always displayed on the screen. Furthermore, in FIG. 7, handwritten strokes 501-503 in the rectangular frame are shaded such that they can be distinguished from other handwritten strokes. However, the display of handwritten strokes 501-503 is not limited to shading. For example, an underline can be displayed under the handwritten strokes in the rectangular frame or the handwritten strokes can be displayed obliquely.

When the page format processor 301D computes different parameters as described above, it computes a value of the above n (or m) from the height of the circumscribed rectangle and the first interval. Since the height of the circumscribed rectangle that surrounds the handwritten letters “ex” is 150 and the first interval is 100, the page format processor 301D computes 1.5 (=150/100) as a value of the above n. Then, the page format processor 301D formats handwritten strokes 501-503 so as to fall within an area interposed between two (=an integer portion of (1.5+1)) ruled lines including the center of gravity of the circumscribed rectangle. More specifically, as illustrated in FIG. 8, the page format processor 301D adjusts the size of handwritten strokes 501-503 which constitute the handwritten letters “ex” such that the handwritten strokes fall within an area interposed between two ruled lines including the center of gravity of the circumscribed rectangle. When the page format processor 301D formats handwritten strokes 501-503, it stores stroke data including a coordinate sequence corresponding to the path of the formatted handwritten letters “ex” in the work memory 401 as new stroke data. This new stroke data is supplied to the handwriting drawing unit 301B.

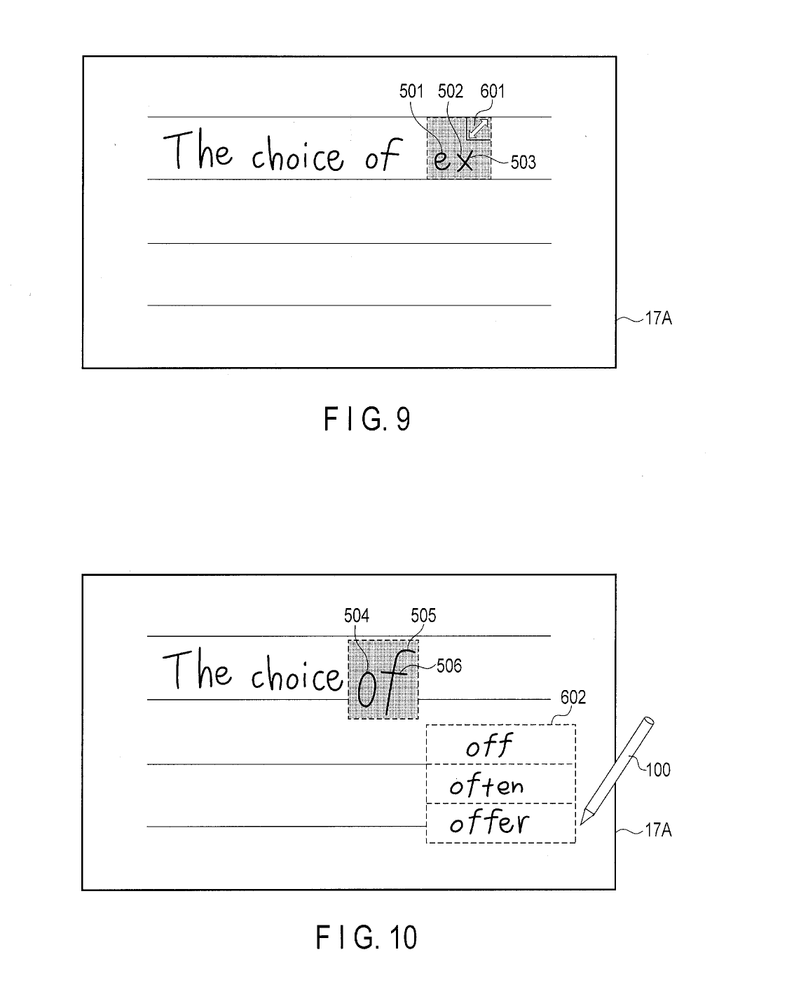

After the page format processor 301D performs the above handwritten page formatting process, a user can tap a scaling icon 601 shown in FIG. 9 to adjust the size of handwritten strokes 501-503 further by hand using an operation method such as pinch-in/pinch-out. When a next stroke is handwritten on the display, the handwritten note application program 202 performs a process to determine handwritten strokes 501-503.

The page format processor 301D can perform a handwritten page formatting process in association with the candidate presenting process of the candidate presentation processor 301C as well as the above-described handwritten page formatting process.

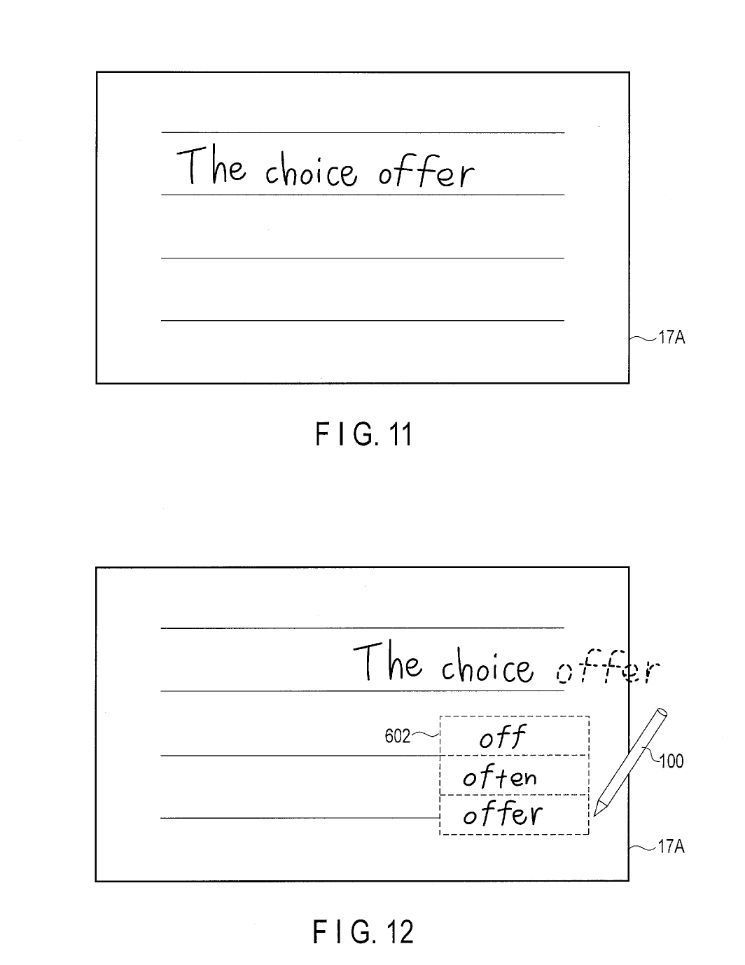

A handwritten page formatting process to be performed in association with the candidate presenting process will be described with reference to FIGS. 10 and 11.

FIGS. 10 and 11 are figures for illustrating a page formatting process to be performed in association with the candidate presenting process. It is assumed here that handwritten strokes 504-506 corresponding to handwritten letters “of” are input after the handwritten strokes corresponding to handwritten letters “The choice” are input.

First, the candidate presentation processor 301C acquires some stroke strings (stroke groups) corresponding to input handwritten strokes 504-506 (corresponding to stroke data) from the candidate stroke database 402B. Then, the candidate presentation processor 301C displays the acquired stroke strings on a candidate stroke list 602. In FIG. 10, three stroke strings “off,” “often” and “offer” are displayed as candidate strokes on the candidate stroke list 602. These three candidate strokes displayed on the candidate stroke list 602 are stroke strings which were input by a user.

When a desired stroke string is selected from the candidate stroke list 602 according to a user's operation and when the handwritten letters “of” corresponding to handwritten strokes 504-506 is n times larger than the first interval, the candidate presentation processor 301C supplies the page format processor 301D with stroke data corresponding to the selected stroke string. It is assumed here that the stroke string “offer” is selected and stroke data corresponding to the selected stroke string is supplied to the page format processor 301D.

When the candidate presentation processor 301C supplies the page format processor 301D with the stroke data corresponding to the stroke string selected from the candidate stroke list 602 according to a user's operation, the page format processor 301D performs a process to surround the handwritten letters “of” corresponding to handwritten strokes 504-506 with a rectangular frame and computes an upper left coordinate, a lower right coordinate, height and center of gravity of the rectangular frame. Then, the page format processor 301D computes a value of the above n on the basis of the computed height of the rectangular frame and the first interval and adjusts the shape of strokes corresponding to the stroke data supplied from the candidate presentation processor 301C such that the strokes fall within an area interposed between n+1 ruled lines including the computed center of gravity. Thus, the page format processor 301D is able to display the screen shown in FIG. 11 on the LCD 17A through the handwriting drawing unit 301B.

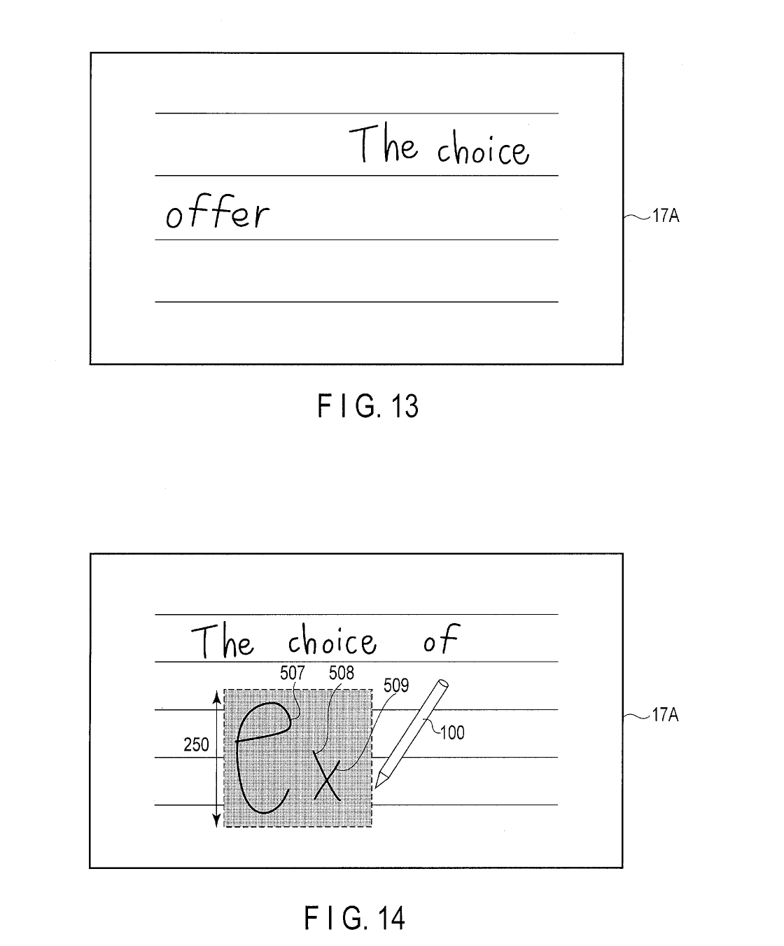

When the size of the strokes corresponding to the stroke data supplied from the candidate presentation processor 301C is adjusted, if it is predicted that the last stroke string does not fall within the page as illustrated in FIG. 12, the page format processor 301D is able to draw the formatted stroke string at the beginning of the next line as illustrated in FIG. 13.

The page format processor 301D is also able to perform a handwritten page formatting process other than the above-described handwritten page formatting process. More specifically, when one or more characters corresponding to a plurality of handwritten strokes are n (n>2) times larger than the first interval, the page format processor 301D is able to perform a handwritten page formatting process to format the shape of a plurality of handwritten strokes in accordance with a size of n times larger than the first interval such that the handwritten strokes fall within an area between n+1 ruled lines. In other words, the page format processor 301D is able to perform a process to adjust the size of the strokes handwritten over a plurality of lines such that the handwritten strokes fall within not one line but a plurality of lines.

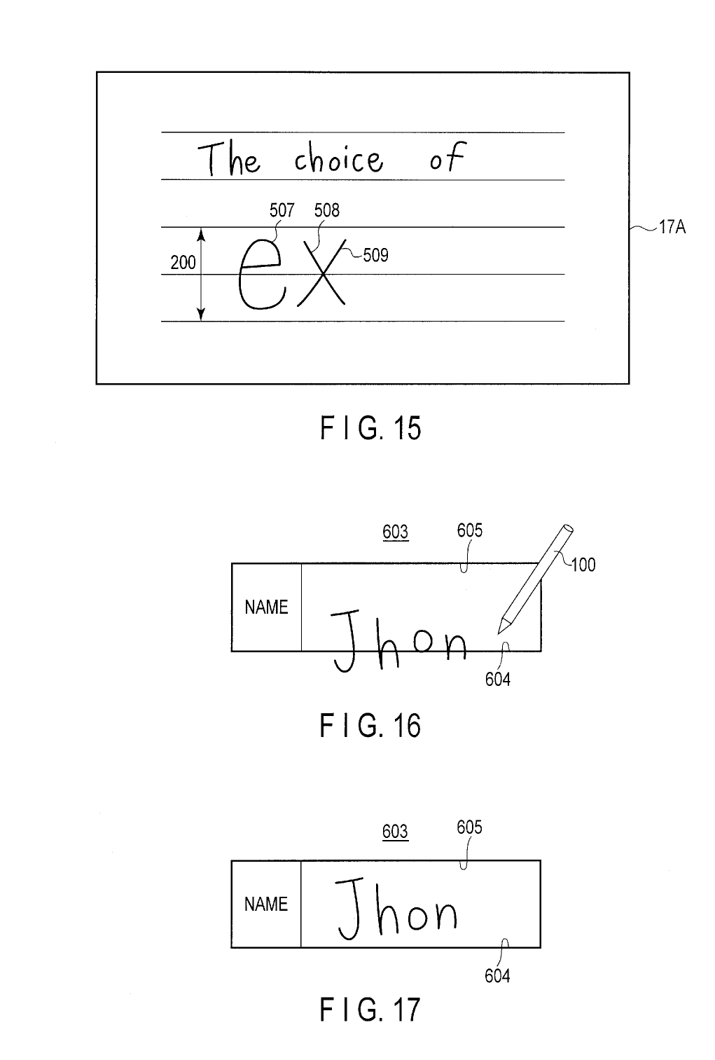

Hereinafter, a handwritten page formatting process to format handwritten strokes (adjust the size of handwritten strokes) such that the handwritten strokes fall within a plurality of lines, will be described with reference to FIGS. 14 and 15.

FIGS. 14 and 15 are figures for illustrating a handwritten page formatting process to format handwritten strokes (adjust the size of handwritten strokes) such that the handwritten strokes fall within a plurality of lines. It is assumed here that handwritten strokes corresponding to handwritten letters “The choice of” are input and then handwritten strokes 507-509 corresponding to the handwritten letters “ex” are input in a line other than the line in which the handwritten strokes corresponding to the handwritten letters “The choice of” are input.

First, as illustrated in FIG. 14, when the handwritten letters “ex” corresponding to handwritten strokes 507-509 is n times larger than the first interval, the page format processor 301D performs a process to surround the handwritten letters “ex” corresponding to handwritten strokes 507-509 with a rectangular frame. After that, the page format processor 301D computes an upper left coordinate, a lower right coordinate, height and center of gravity of the rectangular frame. When the page format processor 301D computes different parameters of the rectangular frame, it computes a value of the above n from the height of the rectangular frame and the first interval. It is assumed here that the height of the rectangular frame that surrounds the handwritten letters “ex” is 250 and the first interval is 100. Accordingly, the value of the n will be 2.5 (=250/100). When the page format processor 301D computes the value of the n, it formats handwritten strokes 507-509 so as to fall within an area interposed between three (=an integer portion of (2.5+1)) ruled lines including the center of gravity of the rectangular frame. Since, in this case, the height 250 of the rectangular frame that surrounds the handwritten letters “ex” has only to be adjusted such that the handwritten letters fall within an area 200 interposed between three ruled lines, the size of handwritten strokes 507-509 is reduced to ⅘ (=200/250) as illustrated in FIG. 15. Thus, the size of the handwritten strokes is not always adjusted to fall within an area of one line but can be adjusted to fall within an area between lines which is near to a user's intended area.

The present embodiment is directed chiefly to the handwritten page formatting process in which strokes are handwritten within a page including a plurality of ruled lines. Even though strokes are handwritten within a page having a specific attribute such as a name list, different handwritten page formatting processes as described above can be applied. For example, it is assumed that strokes corresponding to a handwritten word “Jhon” are handwritten in a name list 603 and these handwritten strokes do not fall within the name list 603, as illustrated in FIG. 16. The page format processor 301D is able to perform the above-described typical handwritten page formatting process by considering segments 604 and 605, which constitute the name list 603, as ruled lines, and to format (adjust) the handwritten strokes corresponding to the handwritten word “Jhon” to fall within the name list 603 (between the segments 604 and 605), as illustrated in FIG. 17.

When the strokes are handwritten in the name list 603 as illustrated in FIGS. 16 and 17, the candidate presentation processor 301C may present a user with a stroke string related to a name as candidate strokes by priority.

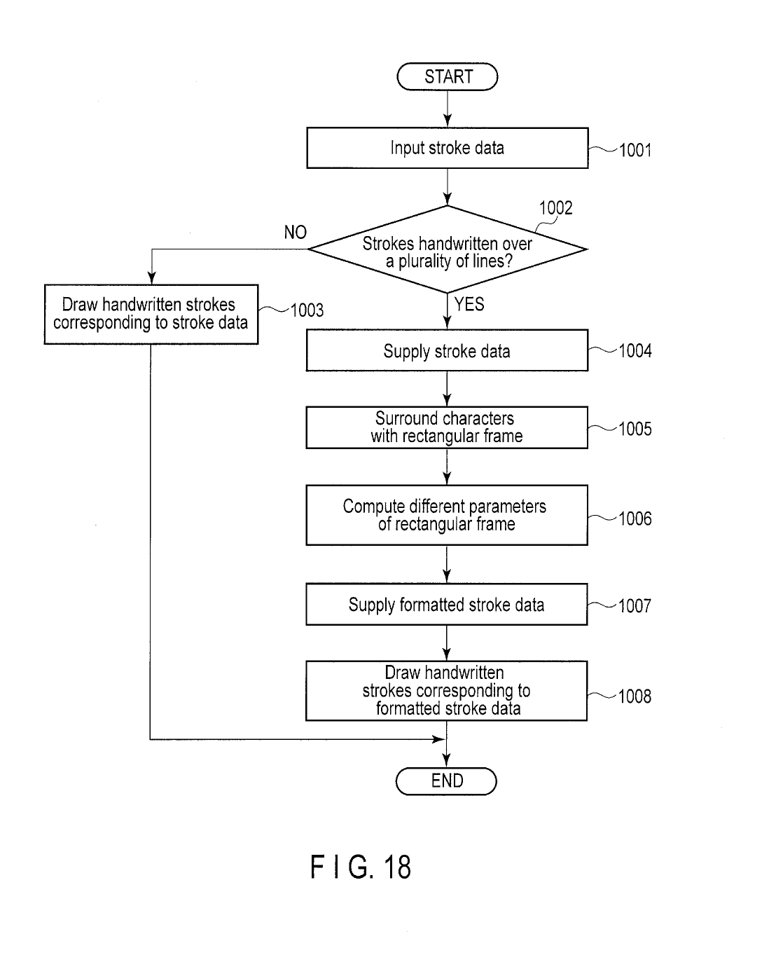

An example of a procedure of the typical handwritten page formatting process to be performed by the handwritten note application program 202 will be described with reference to FIG. 18.

First, the handwritten data input unit 301A inputs stroke data corresponding to strokes handwritten on the display (block 1001). Then, the handwritten data input unit 301A determines whether one or more characters corresponding to a plurality of handwritten strokes corresponding to the input stroke data are n times larger than the first interval (whether a plurality of strokes are handwritten over a plurality of lines) (block 1002). If the one or more characters corresponding to the handwritten strokes are not n times larger than the first interval (NO in block 1002), the handwritten data input unit 301A supplies the input stroke data to the handwriting drawing unit 301B. The handwriting drawing unit 301B draws on the screen a plurality of handwritten strokes corresponding to the stroke data supplied from the handwritten data input unit 301A (block 1003), and the handwritten page formatting process is ended. In other words, there are no handwritten strokes for the handwritten page formatting process and thus the handwritten page formatting process is ended.

If the one or more characters corresponding to the handwritten strokes are n times larger than the first interval (YES in block 1002), the handwritten data input unit 301A supplies the input stroke data to the page format processor 301D (block 1004).

For describing a procedure of the typical handwritten page formatting process, it is assumed here that the handwritten data input unit 301A supplies the stroke data only to the page format processor 301D in block 1004. However, in order to perform a handwritten page formatting process in association with the candidate presenting process, the handwritten data input unit 301A supplies the stroke data to candidate presentation processor 301C, too.

The page format processor 301D performs a process to surround with a rectangular frame one or more characters corresponding to handwritten strokes, which are targeted for the handwritten page formatting process, in a plurality of handwritten strokes corresponding to the stroke data supplied from the handwritten data input unit 301A (block 1005). After that, the page format processor 301D computes an upper left coordinate, a lower right coordinate, height and center of gravity of the rectangular frame (block 1006).

The page format processor 301D computes a value of the above n from the computed height of the rectangular frame and the first interval. After that, the page format processor 301D formats (adjusts) the handwritten strokes in the rectangular frame so as to fall within an area interposed between n+1 ruled lines including the computed center of gravity of the rectangular frame and then supplies the handwriting drawing unit 301B with the stroke data corresponding to the formatted handwritten strokes (block 1007).

After that, the handwriting drawing unit 301B draws on the screen a plurality of handwritten strokes corresponding to the stroke data supplied from the page format processor 301D (block 1008), and the handwritten page formatting process is ended.

According to the embodiment described above, the handwritten note application program 202 includes a page format processor 301D to perform a process for, when strokes are input in handwriting and handwritten over a plurality of ruled lines, displaying on the screen the handwritten strokes to fall within an area interposed between lines close to the handwriting input positions. Accordingly, a smooth handwriting input operation can be achieved.

The process according to the present embodiment can be performed by computer programs. Thus, the same advantage as that of the present embodiment can easily be brought about only by installing the computer programs into a computer and executing them through a computer-readable storage medium that stores the computer programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to:
input one or more characters corresponding to a plurality of handwritten strokes in a region of a display comprising a plurality of ruled lines at first intervals,
adjust a shape of the one or more characters when the size of the one or more characters is n times larger than the first interval, wherein n is greater than 0, and
display the adjusted one or more characters.

2. The electronic device of claim 1, wherein:
the circuitry is further configured to adjust the shape of the one or more characters to fit within an area interposed between [n+1] ruled lines, wherein [n+1] is the integer part of n+1.

3. The electronic device of claim 2, wherein the circuitry is further configured to adjust the shape of the one or more characters.

4. The electronic device of claim 1, wherein:
the circuitry is configured to display a list of one or more input candidate character groups, each of the groups corresponding to one or more input strokes; and
the circuitry is further configured to adjust the shape of one input candidate character group when the group is selected and the size of the one or more characters is larger than the first intervals.

5. The electronic device of claim 4, wherein the circuitry is further configured to adjust a position of the shape-adjusted character group to fit within a line.

6. A method comprising:
inputting one or more characters corresponding to a plurality of handwritten strokes in a region of a plurality of ruled lines at first intervals,
adjusting a shape of the one or more characters when the size of the one or more characters n times larger than the first intervals, wherein n is greater than 0; and
displaying adjusted characters.

7. The method of claim 6, wherein:
adjusting the shape of the one or more characters to fit within an area interposed between [n+1] ruled lines, wherein [n+1] is the integer part of n+1.

8. The method of claim 7, wherein:
further adjusting the shape of the one or more characters.

9. The method of claim 6, wherein:
displaying a list of one or more input candidate character groups, each of groups corresponding to one or more input strokes; and
adjusting the shape of one input candidate character group when the size of the characters is larger than the first intervals.

10. The method of claim 9, further adjusting a position of the shape-adjusted character group to fit within a line.

11. A computer program product having a non-transitory computer-readable medium including programmed instructions for processing handwriting strokes input when executed by a computer, cause the computer to:
input one or more characters corresponding to a plurality of handwritten strokes in a region of a plurality of ruled lines at first intervals;
adjust a shape of the one or more characters, when the size of the one or more characters is n times larger than the first intervals, wherein n is greater than 0; and
display the adjusted one or more characters.

12. The computer program product of claim 11, wherein the instructions further cause the computer to:
adjust the shape of the one or more characters to fit within an area interposed between [n+1] ruled lines, wherein [n+1] is the integer part of n+1.

13. The computer program product of claim 12, wherein the instructions further cause the computer to: further adjust the shape of the one or more characters.

14. The computer program product of claim 11, wherein the instructions further cause the computer to:
display a list of one or more input candidate character groups, each of the groups corresponding to one or more input strokes; and
further adjust the shape of one input candidate character group when the one input candidate character group is selected and when the size of the one or more characters is larger than the first intervals.

15. The computer program product of claim 14, wherein the instructions further cause the computer to: further adjust a position of the shape-adjusted character to fit within a line.
